(19) United States
(12) Patent Application Publication
(10) Pub. No.: US 2019/0141908 A1
(43) Pub. Date: May 16, 2019

(54) Plant Pot Drainer

(71) Applicant: Timothy Michael Moore, Berkley, MI (US)

(72) Inventor: Timothy Michael Moore, Berkley, MI (US)

(21) Appl. No.: 15/814,760

(22) Filed: Nov. 16, 2017

(51) Int. Cl. A01G 9/02; E03C 1/22

(52) U.S. Cl. CPC A01G 9/028; E03C 1/22

(57) ABSTRACT

A device for use within a plant pot with at least one vertically-oriented drainage opening in its base, which facilitates the drainage of excess water from the plant pot while mitigating the loss of growing medium through the drainage opening. The plant pot drainer comprises at least two concentric tiers of structural members having a plurality of horizontally-oriented openings, and an upper body, which is fixed atop the structural members. The horizontally-oriented openings between the structural members are configured to be radially staggered relative to the horizontally-oriented openings of the immediately adjacent tiers of structural members. The radially staggered configuration causes the space between the tiers of structural members to become partially obstructed by growing medium, which impedes the passage of additional growing medium while allowing water to continue to flow and ultimately exit the plant pot through the drainage opening.

### FIELD OF THE INVENTION

The invention pertains to devices for use with vessels that are used for the containment of the medium, in which plants are grown. More specifically, the invention pertains to devices that facilitate the drainage of excess water from plant pots while retaining the growing medium.

### DESCRIPTION OF THE RELATED ART

Plant pots and other vessels commonly used to contain growing medium in which plants are grown often have at least one vertically-oriented drainage opening located in their base in order to allow excess water to drain from the growing medium. Such openings are desirable features in plant pots because they prevent the water used to irrigate the growing medium from accumulating in the plant pot, which can be harmful to plants. However, growing medium particulate can pass through these openings, which can result in undesirable loss of growing medium.

A common method of preventing the loss of growing medium through the drainage opening while permitting excess water to be drained from the plant pot is to partially obstruct the opening with fragments of broken terracotta plant pots or small stones. The effectiveness of this method is inconsistent due of the irregular form of the materials commonly used to partially obstruct the drainage opening, which can conceivably produce the undesirable effects of failing to substantially retain growing medium or wholly inhibiting excess water from draining through the opening.

U.S. Pat. No. 7,743,554 B2 describes a device comprising a planar body supported by at least three leg members, the perimeter of which is encircled with mesh.

U.S. Pat. No. 5,448,854 A describes a device comprising a body having a plurality of vertically-oriented openings dispersed throughout, and multiple stabilizer members that are intended to be inserted into the drainage opening of a plant pot.

U.S. Pat. No. 4,860,491 A describes a device comprising a disk having vertically-oriented openings dispersed throughout, and a stepped projection extending from the center of the bottom surface of the disk. The stepped projection is inserted into the drainage opening located at the bottom of a plant pot. In order for the device to function as intended the diameter of at least one step of the stepped projection must correspond with the diameter of the drainage opening such that snug mating is achieved. Being adapted in size to achieve snug mating upon insertion into the standard size drainage openings in common plant pots, it is conceivable that the stepped projection might be incompatible with drainage openings of irregular or non-standard size or shape.

U.S. Pat. No. 1,884,204 A describes a device comprising a plurality of arms being curved, such that the central portion thereof is raised above the drainage opening located at the bottom of a plant pot.

U.S. Pat. No. 611,523 A describes a device comprising an imperforate plate having radial grooves in its bottom surface, which is deposited within a plant pot over the drainage opening in the bottom thereof.

### BRIEF SUMMARY OF THE INVENTION

The present invention is intended for use with plant pots, which have at least one vertically-oriented drainage opening located in their base. When placed within a plant pot directly covering the drainage opening and prior to the plant pot being filled with growing medium, the invention functions to facilitate drainage of excess water from the plant pot through the drainage opening, and mitigate the loss of growing medium from the plant pot through the drainage opening.

The invention comprises an upper body, which is supported by at least two concentric tiers of structural members configured such that the horizontally-oriented openings between the structural members of each tier are racially staggered relative to the openings of the immediately adjacent tiers of structural members. This configuration of radially staggered horizontally-oriented openings created by arranging the tiers such that an opening between two structural members of an outer tier is centrally aligned with a structural member of an inner tier, is a crucial element of the invention. Being situated directly and completely on top of the drainage opening at the bottom of a plant pot, excess water is allowed to flow horizontally toward the center of the device through the openings between the structural members, and ultimately though the drainage opening. Growing medium particulate accumulates in the space between the tiers of structural members rather than exiting the plant pot through the drainage opening. When accumulated within the invention, most commonly used growing medium will not wholly inhibit water from flowing through the drainage opening. However, the invention will produce the effect of substantially reducing the amount of growing medium that is lost from the plant pot through the drainage opening.

An object of the invention is to provide a device that facilitates the drainage of excess water from a plant pot through a drainage opening, while mitigating the loss of growing medium from the plant pot through the drainage opening.

Another object of the invention is to provide a device that, when embodied in a single size, is compatible for use with plant pots and drainage openings of varying size and shape.

### BRIEF DESCRIPTION OF THE DRAWINGS

FIG. 1 is a perspective view of the present invention.

FIG. 2 is an exploded perspective view of the present invention, showing the upper body, an inner tier of structural members, and the outer tier of structural members.

FIG. 3 is a perspective view of the bottom of the present invention.

FIG. 4 is a cross sectional view of the present invention in a common plant pot.

### DETAILED DESCRIPTION OF THE INVENTION

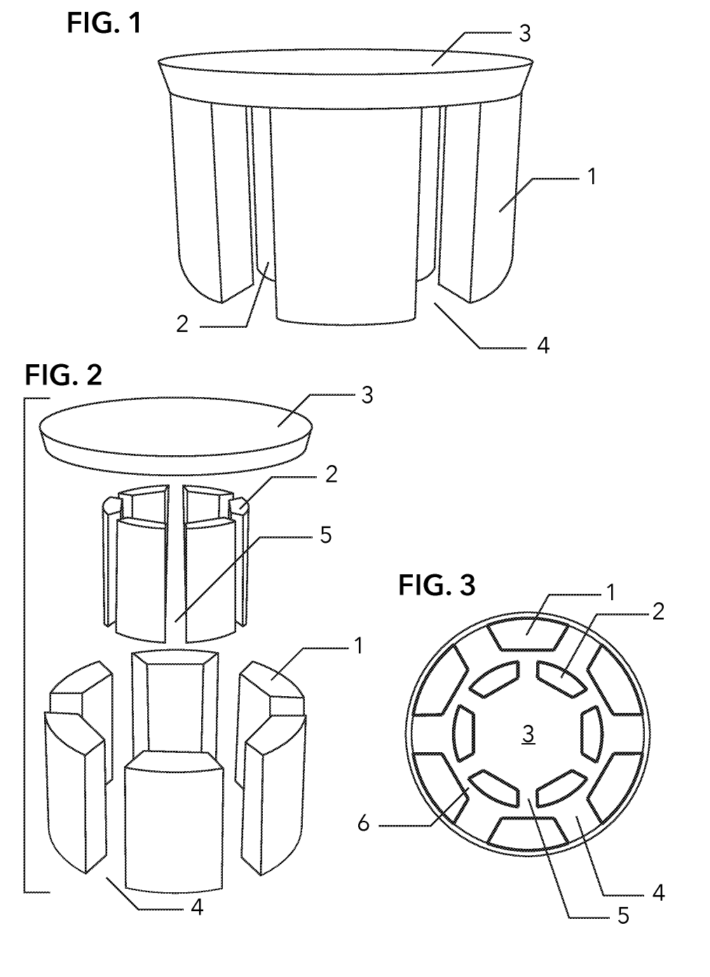

Referring to the drawings in detail, and to FIG. 1 in particular, which shows the present invention. The invention comprises an upper body 3, an outer tier of structural members 1, and at least one inner tier of structural members 2.

FIG. 2 shows an exploded view of the present invention to distinguish its important features. While shown here as separate parts for the purpose of showing their relationship, the present invention is embodied as a single piece of moldable material, such as plastic, which is manufactured by injection molding or another process that will yield a similar product. The upper body 3 is situated atop concentric tiers of structural members 1, 2, and has a horizontal surface area that completely covers the footprint of the structural members 1, 2. The purpose of the upper body 3 is to fix the inner 2 and outer 1 tiers of structural members in a configuration of radially staggered horizontally-oriented openings, and, being of impermeable material and having no openings, to restrict excess water and growing medium particulate to passing through the openings between the structural members 4, 5 toward the drainage opening of the plant pot 8 horizontally inward rather than vertically downward.

The outer 1 and inner 2 tiers of structural members comprise a plurality of structural members that extend downward from the bottom surface of the upper body 3, and rest evenly upon the bottom surface of the plant pot interior 9 surrounding the drainage opening 8. The structural members 1, 2 have a uniform height, and when the present invention is embodied in a single size it will be of a height compatible for use with most commercially available plant pots of varying depth. The bottom surface of every structural member 1, 2 will have uniform contact with the bottom surface of the plant pot interior 9 when placed upon it. The present invention is so designed to be held in its intended position by only the bulk of the growing medium surrounding it. A suitable adhesive may optionally be applied to the bottom surface of the structural members 1, 2 to affix the present invention to the bottom surface of the plant pot interior 9 in the correct position.

The present invention has at least one inner tier of structural members 2, and may have more than one. The inner tier of structural members 2 is situated within the perimeter of the outer tier of structural members 1 such that the paths of the individual tiers do not intersect. The individual tiers of structural members are arranged relative to each other in a configuration of radially staggered horizontally-oriented openings such that every opening between the structural members of the inner tier 5 is centrally aligned with a structural member of the outer tier 1, and every opening between the structural members of the outer tier 4 is centrally aligned with a structural member of the inner tier 2. If an embodiment of the present invention has more than one inner tier of structural members 2, then each more inward tier will continue the configuration of radially staggered horizontally-oriented openings corresponding with the immediate more outward tier.

The structural members 1, 2 have flat or gently curved side surfaces, and have all dimensions equal to those of the other structural members in their respective tier. The structural members of each tier are arranged such that the structural members 1, 2 are equally distributed throughout the perimeter of a circle or other closed shape. The horizontally-oriented openings between the structural members of their respective tier are of uniform size. The dimensions of the structural members of each inner tier 2 and the openings between them 5 are progressively smaller than those of the immediate more outward tier. The size of the horizontally-oriented openings between each structural members 4, 5 are conducive to facilitating the drainage of excess water from the plant pot while mitigating the loss of growing medium through the drainage opening 8.

The inner tier of structural members 2 that is immediately adjacent to the outer tier of structural members 1 is situated such that the space between the tiers 6 is of sufficient width to allow water to flow. However, the space between tiers 6 is narrower than the width of the horizontally-oriented openings between the structural members 4 of the more outward tier. The configuration of radially staggered horizontally-oriented openings arrests growing medium particulate in the narrower space between the tiers of structural members 6. The resulting partial obstruction impedes the further passage of growing medium while allowing excess water to flow and ultimately exit the plant pot through the drainage opening 8.

The configuration of radially staggered horizontally-oriented openings between the outer 1 and inner 2 tiers of structural members is observed in FIG. 3, which shows the present invention as viewed from the bottom.

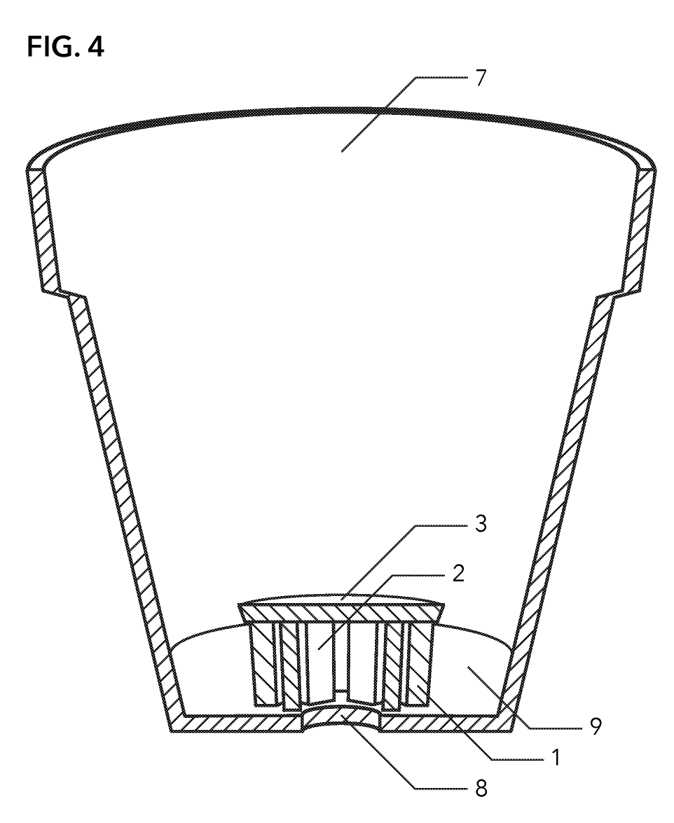

FIG. 4 shows a cross section of the present invention in its intended position inside a common plant pot 7. The present invention is situated on the bottom surface of the plant pot interior 9 directly above the drainage opening 8, with which it is centrally aligned. The interior diameter of at least one inner tier of structural members 2 is greater than the diameter of the drainage openings 8 of most commercially available plant pots.

Although preferred embodiments of the invention have been described in detail and illustrated in the accompanying drawings, it should be understood that various changes, substitutions, and alterations can be made therein without departing from the spirit and/or scope of the present invention as defined by the appended claims.

1. I claim a plant pot drainer for use within a plant pot having at least one vertically-oriented drainage opening in its base, said plant pot drainer comprising at least two concentric tiers of structural members, each containing a plurality of horizontally-oriented openings that are arranged in staggered radial alignment relative to the horizontally-oriented openings of the immediately adjacent tiers of structural members.
